(19) United States
(12) Patent Application Publication
(10) Pub. No.: US 2019/0311423 A1
(43) Pub. Date: Oct. 10, 2019

(54) VIRTUAL APPAREL SOFTWARE SYSTEM AND METHOD

(71) Applicant: Lucas Petar Koren, Mississauga (CA)

(72) Inventor: Lucas Petar Koren, Mississauga (CA)

(21) Appl. No.: 15/947,670

(22) Filed: Apr. 6, 2018

(51) Int. Cl. G06Q 30/06; G06Q 30/04; G06Q 20/10; G06T 15/20; H04L 29/08

(52) U.S. Cl. CPC G06Q 30/0643; G06Q 30/04; H04L 67/306; G06Q 20/102; G06T 15/205; G06Q 30/0633

(57) ABSTRACT

A virtual apparel software system and method; the method includes providing a virtual apparel software system including a computing device hosting an application and in communication with a retail supplier via a communication network. At least one catalog is coupled to the computing device and storing therein at least one apparel selection. The retail supplier remotely provides the at least one apparel selection to the at least one catalog. The application may further include a means for generating a 3D replica of a consumer. The 3D replica may be useful for displaying the at least one apparel selection in actual size thereon. The virtual apparel software system and method is used to improve overall consumer experience when online shopping.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of software application of existing art and more specifically relates to virtual apparel modeling.

### RELATED ART

Online shopping has become a more prevalent form of consumer shopping for apparel. Apparel can be searched and purchased all from the convenience of a consumer's computer. However, there are ordeals associated with online shopping. When shopping in person, the consumer is able to try apparel on their body in order to find the appropriate size. The consumer is not able to do so when online shopping. Receiving an appropriate size can often take numerous attempts and expend a considerable period of time on the consumer. Further, consumers often have to spend time on multiple online sites when shopping and finding appropriate sizes, causing inconvenience and burden to the consumer. Therefore, a suitable solution is desired.

U.S. Pub. No. 2012/0095589 to Arkady Vapnik relates to a method of detecting the 3D shape of human body and a system of providing Virtual Fitting Room (VFR) service to online retailers over the Internet, in which customer films her/his body moving in front of the camera in a body suit with visible markers. Film is uploaded to the VFR system and processed there by extracting markers coordinates, by tracking markers from frame to frame to achieve automatic registration, and by performing photogrammetric processing of the marker coordinates to obtain and store 3D shape of the customer body. Customer selects an apparel item on an online retailer website, online retailer computer sends a request for fitting service to the VFR system, VFR system retrieves and processes customer digitized 3D body shape and digitized representation of the apparel item, returns virtual images of the customer fitted in the item to online retailer for display of the images to customer.

### SUMMARY OF THE INVENTION

In view of the foregoing disadvantages inherent in the known virtual apparel modeling art, the present disclosure provides a novel virtual apparel software system and method. The general purpose of the present disclosure, which will be described subsequently in greater detail, is to provide an effective and efficient virtual apparel software system and method.

A method of using a virtual apparel software system is disclosed herein. The method of using the virtual apparel software system includes providing the virtual apparel software system, comprising: a computing device hosting an application and in communication with a retail supplier via a communication network, and at least one catalog coupled to the computing device and storing therein at least one apparel selection. The retail supplier may remotely provide the at least one apparel selection to the at least one catalog. The method may further include registering a profile associated with a consumer; receiving a series of prompts for body-dimensions of the consumer; generating a 3D replica of the consumer; selecting the at least one apparel selection from the at least one catalog; adjusting a size associated with the at least one apparel selection such that it correlates to the body-dimensions of the consumer; displaying the at least one apparel selection on the 3D replica; purchasing the at least one apparel selection; and sending a payment-invoice for the purchase of the at least one apparel selection to the retail supplier such that the retail supplier receives a percentage of sales associated with the purchase of the at least one apparel selection.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a virtual apparel software system and method, constructed and operative according to the teachings of the present disclosure.

FIG. 1 is a flow diagram illustrating a method of using a virtual apparel software system, according to an embodiment of the present disclosure.

FIG. 2 is a perspective view of the virtual apparel software system during an ‘in-use’ condition, according to an embodiment of the disclosure.

FIG. 3 is a flow diagram of the virtual apparel software system of FIG. 1, according to an embodiment of the present disclosure.

FIG. 4 is a perceptive view of the virtual apparel software system of FIG. 1, according to an embodiment of the present disclosure.

FIG. 5 is a perspective view of the virtual apparel software system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a virtual apparel modeling and more particularly to a virtual apparel software system and method as used to improve overall consumer experience when online shopping.

Generally, the present invention may effectively ensure products will ‘fit’ the consumer when it arrives at their door and allow them to create looks and pick styles. The software application may make an online apparel purchase a confident one for the consumer. Apparel retailers can partner with the application in order to occur a decrease in returns expenses and an increase in payment-invoices as a result. Apparel may include clothing, jewelry, shoes, and the like. Further, the software application can act as an online gathering place or mall for consumers to find and try on apparel virtually.

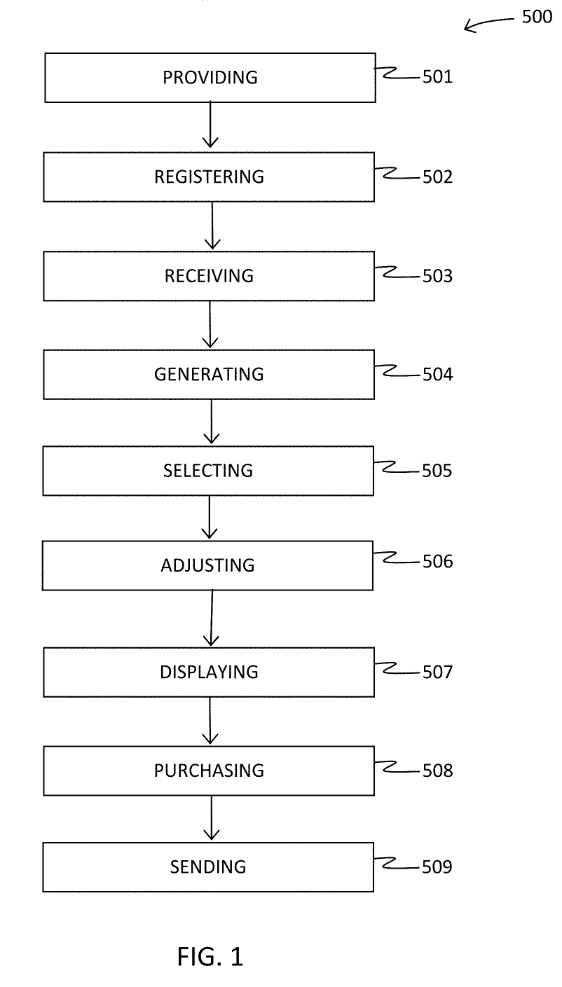

Referring now more specifically to the drawings by numerals of reference, there is shown in FIGS. 1-5, various views and flowcharts of a virtual apparel software system and method 500.

FIG. 1 shows a flow diagram of a method of using a virtual apparel software system 500, according to an embodiment of the present disclosure. In particular, the method of using the virtual apparel software system 500 may include one or more components or features of a virtual apparel software system 100. Here, the method of using the virtual apparel software system 500 may be beneficial for use by a consumer 40 to provide virtual apparel modeling of the consumer 40 in a 3D replica 120. As illustrated, the method of using the virtual apparel software system 500 may include step one 501, providing the virtual apparel software system 100, comprising: a computing device 110 hosting an application 115 and in communication with a retail supplier 113 via a communication network 124, and at least one catalog 114 coupled to the computing device 110 and storing therein at least one apparel selection 116. The retail supplier 113 may remotely provide the at least one apparel selection 116 to the at least one catalog 114.

The method 500 may further include step two 502, registering a profile associated with the consumer 40; step three 503, receiving a series of prompts 118 for body-dimensions of the consumer 40; step four 504, generating the 3D replica 120 of the consumer 40; step five 505, selecting the at least one apparel selection 116 from the at least one catalog 114; step six 506, adjusting a size associated with the at least one apparel selection 116 such that it correlates to the body-dimensions of the consumer 40; step seven 507, displaying the at least one apparel selection 116 on the 3D replica 120; step eight 508, purchasing the at least one apparel selection 116; and step nine 509, sending a payment-invoice for the purchase of the at least one apparel selection 116 to the retail supplier 113 such that the retail supplier 113 receives a percentage of sales associated with the purchase of the at least one apparel selection 116.

In addition, the method 500 may include the steps of customizing the 3D replica 120. Customizing may include changing a plurality of physical characteristics associated with the 3D replica 120. Physical characteristics refer to hair, skin, tattoos, or the like. This may enable the 3D replica 120 to become more personal to the consumer 40. Furthermore, the profile may include a functional consumer-image for additional personalization. The consumer-image can be displayable on the 3D replica 120. The 3D replica 120 may be understood as a computerized representation of the consumer 40.

The method 500 may further include adding other consumer(s) to a contact-list 126 such that the other consumer(s) are easily accessible via the application 115. The consumer 40 may be able to purchase the at least one apparel selection 116 for the other consumer(s) on the contact-list 126 as a gift. The size of the at least one apparel selection 116 may automatically adjust to the body-dimensions associated with the other consumer(s) on the contact-list 126. However, the body-dimensions of the other consumer(s) may not be viewable or made public to the consumer 40 when purchasing the gift.

The present invention may be useful for partnering retailer suppliers 113 on a single online platform. The method 500 may include licensing the application 115 to the retail suppliers 113 to provide access to the at least one catalog 114, such that the at least one apparel selection 116 is made available in one place for convenience to the consumer 40. The application 115 can act as a virtual mall to benefit the consumer 40 and their online shopping experience. The consumer 40 may have virtually unlimited and free access to the application 115 with the method of using the virtual apparel software system 500.

It should also be noted that the steps described in the method of use 500 can be carried out in many different orders according to consumer 40 preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the virtual apparel software system 100 (e.g., different step orders within above-mentioned list, elimination or addition of certain steps, including or excluding certain steps, etc.), are taught herein.

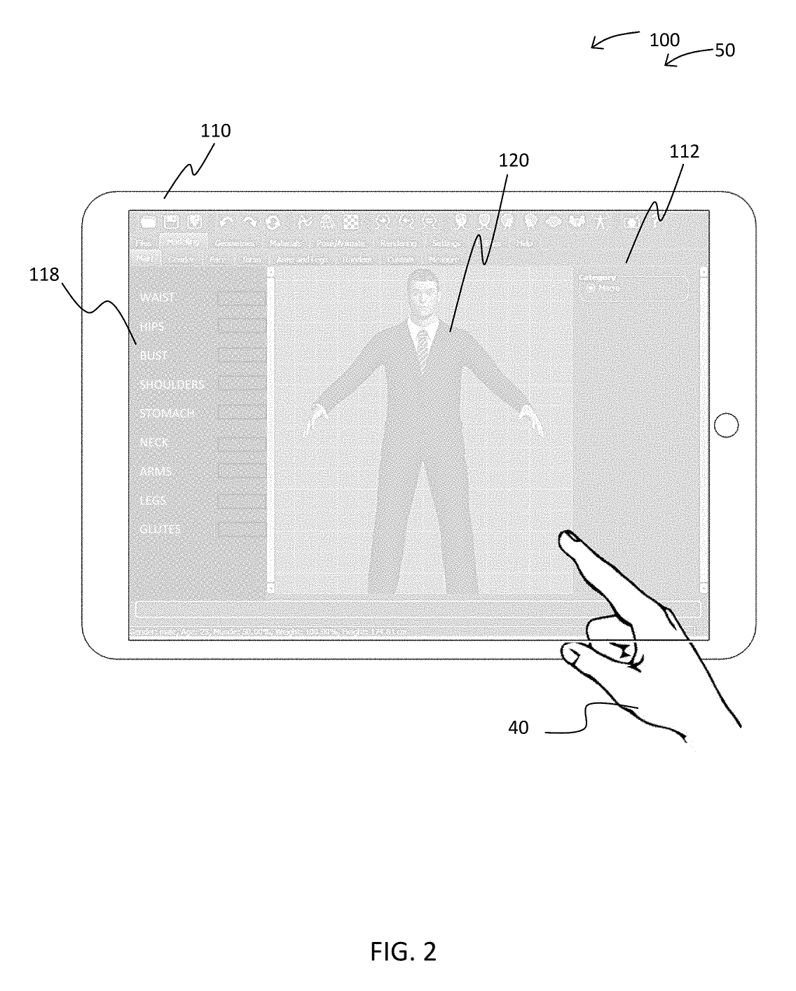

FIG. 2 shows the virtual apparel software system 100 of FIG. 1 during an in-use condition 50, according to an embodiment of the present disclosure. As above, the virtual apparel software system 100 may include the computing device 110 hosting the application 115 and in communication with the retail supplier 113 via the communication network 124, and the at least one catalog 114 may be coupled to the computing device 110 and storing therein the at least one apparel selection 116. The retail supplier 113 may remotely provide the at least one apparel selection 116 to the at least one catalog 114.

An interface 112 may be coupled to the computing device 110 enabling the consumer 40 to interact with the application 115. The interface 112 is selected from a group consisting of touch capacitive displays, keyboards, buttons, switches, and the like.

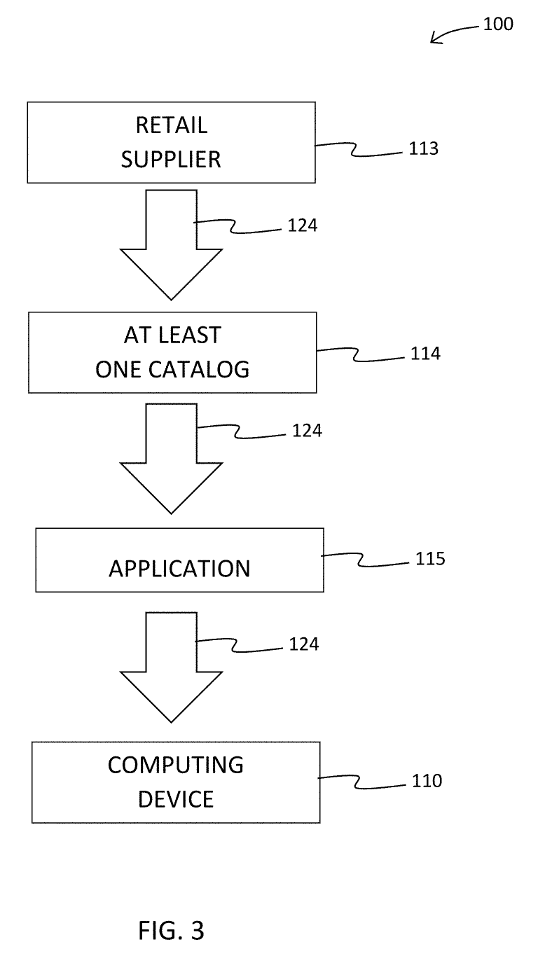

Referring now to FIG. 3 showing a flow diagram view of the virtual apparel software system 100 of FIG. 1, according to an embodiment of the present disclosure. The communication network 124 may be wireless. The retail supplier 113 may provide the at least one apparel selection 116 to the at least one catalog 114 on the application 115 for viewing with the computing device 110 wirelessly. The flow diagram details these steps. Those with ordinary skill in the art will now appreciate that upon reading this specification and by their understanding the art of applications and communication network 124s as described herein, methods of using the application with communication network 124 will be understood by those knowledgeable in such art

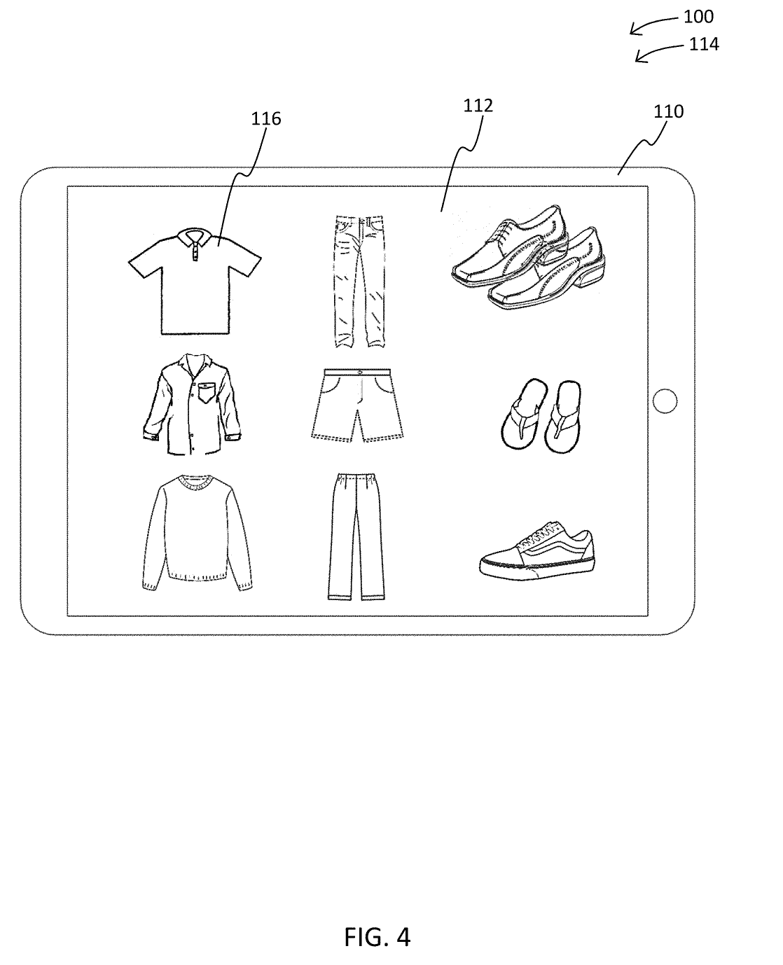

FIG. 4 is a perspective view of the virtual apparel software system 100 of FIG. 1, according to an embodiment of the present disclosure. A processor may be coupled to the computing device 110 for enabling the at least one apparel selection 116 to be displayed on the 3D replica 120 in the size. The size may be a computer representation of the appropriate size of apparel for the consumer 40 according to inputted body-dimensions. The processor may enable the at least one apparel selection 116 to be converted from a 2D viewing on the at least one catalog 114 to a 3D viewing on the 3D replica 120 and configured to allow the consumer 40 to visualize how the at least one apparel selection 116 would look in the size.

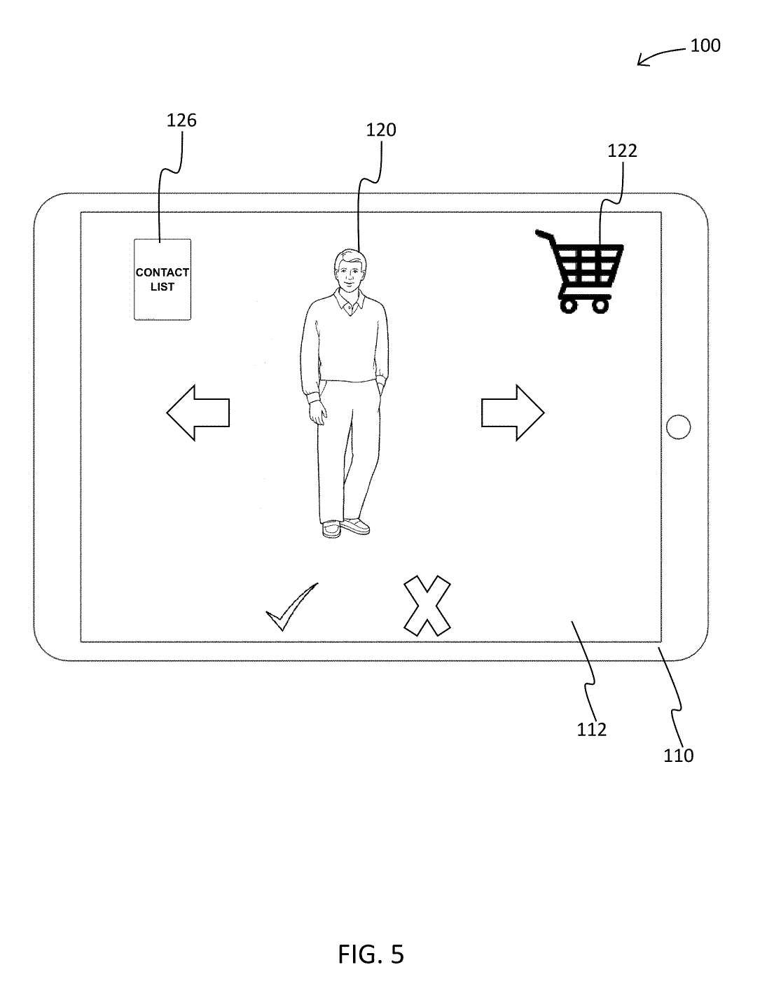

Referring now to FIG. 5 a perspective view of the virtual apparel software system 100 of FIG. 1, according to an embodiment of the present disclosure. As stated above, the interface 112 may be coupled to the computing device 110 enabling the consumer 40 to interact with the application 115. The body-dimensions may be inputted via the series of prompts 118 on the interface 112. The series of prompts 118 for body-dimensions may include a combination of waist, hips, bust, shoulders, stomach, neck, arms, legs, and glutes. The series of prompts 118 for body-dimensions may not be limited to those listed and can be adjusted according to improvements or modifications of the application 115. The interface 112 may further enable a drag-and-drop of the at least one apparel selection 116 from the at least one catalog 114 to the 3D replica 120, such that the at least one apparel selection 116 is displayable on the 3D replica 120. Further, the interface 112 may include a shopping-cart 122, or a means for accessing the shopping-cart 122 associated with the application 115. The shopping-cart 122 may enable purchases of the at least one apparel selection 116 through the application 115. The contact-list 126 may further be accessible on the interface 112.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A virtual apparel software system and method for implementing apparel on a 3D replica, the method comprising:
providing said virtual apparel software system, comprising:
a computing device hosting an application and in communication with a retail supplier via a communication network;
at least one catalog coupled to said computing device and storing therein at least one apparel selection; and
wherein said retail supplier remotely provides said at least one apparel selection to said at least one catalog;
registering a profile associated with a consumer;
receiving a series of prompts for body-dimensions of said consumer;
generating a 3D replica of said consumer;
selecting said at least one apparel selection from said at least one catalog;
adjusting a size associated with said at least one apparel selection such that it correlates to said body-dimensions of said consumer;
displaying said at least one apparel selection on said 3D replica;
purchasing said at least one apparel selection; and
sending a payment-invoice for purchase of said at least one apparel selection to said retail supplier such that said retail supplier receives a percentage of sales associated with the purchase of said at least one apparel selection.

2. The method of claim 1, further comprising customizing said 3D replica.

3. The method of claim 2, wherein customizing includes changing a plurality of physical characteristics associated with said 3D replica.

4. The method of claim 1, wherein said series of prompts for body-dimensions include a combination of waist, hips, bust, shoulders, stomach, neck, arms, legs, and glutes.

5. The method of claim 1, wherein said profile includes a functional consumer-image.

6. The method of claim 5, wherein said consumer-image is displayable on said 3D replica.

7. The method of claim 1, further comprising adding other consumer(s) to a contact-list.

8. The method of claim 7, wherein said consumer is able to purchase said at least one apparel selection for said other consumer(s) on said contact-list.

9. The method of claim 8, wherein said size of said at least one apparel selection adjusts to said body-dimensions associated with said other consumer(s) on said contact-list.

10. The method of claim 1, further comprising licensing said application to said retail suppliers to provide access to said at least one catalog.

11. A virtual apparel software system comprising
a computing device hosting an application and in communication with a retail supplier via a communication network;
at least one catalog coupled to said computing device and storing therein at least one apparel selection; and
wherein said retail supplier remotely provides said at least one apparel selection to said at least one catalog.

12. The virtual apparel software system and method of claim 11, further comprising an interface coupled to said computing device enabling said consumer to interact with said application.

13. The virtual apparel software system and method of claim 12, wherein said body-dimensions are inputted via said series of prompts on said interface.

14. The virtual apparel software system and method of claim 12, wherein said interface enables a drag-and-drop of said at least one apparel selection from said at least one catalog to said 3D replica.

15. The virtual apparel software system and method of claim 12, wherein said interface includes a shopping-cart.

16. The virtual apparel software system and method of claim 15, wherein said shopping-cart enables purchases of said at least one apparel selection through said application.

17. The virtual apparel software system and method of claim 11, further comprising a processor coupled to said computing device for enabling said at least one apparel selection to be displayed on said 3D replica in said size.

18. The virtual apparel software system and method of claim 17, wherein said processor enables said at least one apparel selection to be converted from a 2D viewing on said at least one catalog to a 3D viewing on said 3D replica, and configured to allow said consumer to visualize how said at least one apparel selection would look in said size.

19. The virtual apparel software system and method of claim 11, wherein said communication network is wireless.

20. A virtual apparel software system and method comprising:
providing said virtual apparel software system, comprising:
a computing device hosting an application and in communication with a retail supplier via a communication network;
at least one catalog coupled to said computing device and storing therein at least one apparel selection; and
wherein said retail supplier remotely provides said at least one apparel selection to said at least one catalog;
registering a profile associated with a consumer;
receiving a series of prompts for body-dimensions of said consumer;
generating a 3D replica of said consumer;
selecting said at least one apparel selection from said at least one catalog;
adjusting a size associated with said at least one apparel selection such that it correlates to said body-dimensions of said consumer;
displaying said at least one apparel selection on said 3D replica;
purchasing said at least one apparel selection;
sending a payment-invoice for purchase of said at least one apparel selection to said retail supplier such that said retail supplier receives a percentage of sales associated with the purchase of said at least one apparel selection;
further comprising customizing said 3D replica;
wherein customizing includes changing a plurality of physical characteristics associated with said 3D replica;
wherein said series of prompts for body-dimensions include a combination of waist, hips, bust, shoulders, stomach, neck, arms, legs, and glutes;
wherein said profile includes a functional consumer-image;
wherein said consumer-image is displayable on said 3D replica;
further comprising adding other consumer(s) to a contact-list;
wherein said consumer is able to purchase said at least one apparel selection for said other consumer(s) on said contact-list;
wherein said size of said at least one apparel selection adjusts to said body-dimensions associated with said other consumer(s) on said contact-list;
further comprising licensing said application to said retail suppliers to provide access to said at least one catalog;
further comprising an interface coupled to said computing device enabling said consumer to interact with said application;
wherein said body-dimensions are inputted via said series of prompts on said interface;
wherein said interface enables a drag-and-drop of said at least one apparel selection from said at least one catalog to said 3D replica;
wherein said interface includes a shopping-cart;
wherein said shopping-cart enables purchases of said at least one apparel selection through said application;
further comprising a processor coupled to said computing device for enabling said at least one apparel selection to be displayed on said 3D replica in said size;
wherein said processor enables said at least one apparel selection to be converted from a 2D viewing on said at least one catalog to a 3D viewing on said 3D replica, and configured to allow said consumer to visualize how said at least one apparel selection would look in said size; and
wherein said communication network is wireless.
